(19) United States
(12) Patent Application Publication
(10) Pub. No.: US 2026/0366542 A1
(43) Pub. Date: Nov. 19, 2026

(54) HYDRAULIC GENERATOR DRIVE

(71) Applicant: Brandt Industries Canada Ltd., Regina (CA)

(72) Inventors: Richard Copeland, Buena Vista (CA); Mitchell Schmidt, Regina (CA); Daniel Bonnet, Regina (CA)

(21) Appl. No.: 19/088,115

(22) Filed: Mar. 24, 2025

(51) Int. Cl. F15B 13/02; F15B 15/18

(52) U.S. Cl. CPC F15B 13/026; F15B 13/024; F15B 15/18; F15B 2211/465

(57) ABSTRACT

A hydraulic system and a hydraulic circuit for driving an electrical generator is provided. The hydraulic circuit can include an electrical generator connected to one or more electrical components, a meter in pressure control assembly, upstream from the electrical generator, supplying hydraulic fluid to the electrical generator at a substantially constant desired operating pressure, and a meter out flow control assembly, downstream from the electrical generator, controlling the flow of hydraulic fluid out of the electrical generator at a substantially constant flow rate. The hydraulic system can include a hydraulic fluid source, a hydraulic pump fluidly connected to the hydraulic fluid source, a main hydraulic circuit supplied with hydraulic fluid by the hydraulic pump, and a hydraulic generator circuit, comprising an electrical generator, supplied with hydraulic fluid by the hydraulic pump.

The invention relates to a hydraulic circuit and more particularly a hydraulic circuit for supplying hydraulic fluid to an electrical generator.

### BACKGROUND

Hydraulic driven generators can be used on mobile equipment to power large DC magnets, computer systems, or any equipment requiring an alternating current power source. To provide the required electrical power and/or voltage frequency, the generator must operate at a stable rpm and within a narrow rpm band. Due to the high inertia of the generator rotor, it can be difficult to maintain a stable generator speed without dedicated hydraulic pumps and sophisticated control (PID) algorithms.

When installing a hydraulic driven generator on an existing excavator or other mobile equipment, it is desirable, if not necessary, to use the existing excavator hydraulic pumps, which are already supplying the other hydraulic components already on the excavator or other mobile equipment, as a flow source to drive the electrical generator. Interactions between the existing hydraulic functions and the added generator drive circuit are particularly problematic in maintaining generator speed.

If the speed of the hydraulic generator is not maintained within limits, many generators reduce output or switch off to protect the generator. In the case of electromagnets, this can result in the dropping of the load. In the case of AC powered electronics, fluctuations in the power source can affect their performance and operating outside of their frequency limits can damage components.

A popular method of attempting to stabilizing generator speed is to induce backpressure on the hydraulic motor driving the generator. This controls the overrunning characteristics of the high inertia rotor but also represents loss of efficiency in the hydraulic system and creates additional heat in the hydraulic system which must be rejected by the hydraulic cooling system.

### SUMMARY OF THE INVENTION

In an aspect, a hydraulic circuit for driving an electrical generator is provided. The hydraulic circuit can include an electrical generator connected to one or more electrical components, a meter in pressure control assembly, upstream from the electrical generator, supplying hydraulic fluid to the electrical generator at a substantially constant desired operating pressure, and a meter out flow control assembly, downstream from the electrical generator, controlling the flow of hydraulic fluid out of the electrical generator at a substantially constant flow rate.

In a further aspect, a hydraulic system for a piece of mobile equipment is provided. The system can include a hydraulic fluid source, a hydraulic pump fluidly connected to the hydraulic fluid source, a main hydraulic circuit supplied with hydraulic fluid by the hydraulic pump, and a hydraulic generator circuit, comprising an electrical generator, supplied with hydraulic fluid by the hydraulic pump.

In a further aspect, in the hydraulic system, hydraulic fluid is supplied to the hydraulic generator circuit by the hydraulic pump before the hydraulic fluid is routed to the main hydraulic circuit.

In a further aspect, the hydraulic generator circuit in the hydraulic system can include an electrical generator connected to one or more electrical components, a meter in pressure control assembly upstream from the electrical generator, supplying hydraulic fluid to the electrical generator at a substantially constant desired operating pressure, and a meter out flow control assembly downstream from the electrical generator, controlling the flow of hydraulic fluid out of the electrical generator at a substantially constant flow rate.

### DESCRIPTION OF THE DRAWINGS

A preferred embodiment of the present invention is described below with reference to the accompanying drawings, in which:

FIG. 1 is a schematic illustration of a main hydraulic circuit and an additional hydraulic generator circuit having hydraulic fluid supplied from a single hydraulic fluid source and hydraulic pump;

FIG. 2 is a schematic illustration of a hydraulic circuit for supplying hydraulic fluid to an electrical generator in an aspect; and

FIG. 3 is a schematic illustration of a hydraulic circuit for supplying hydraulic fluid to an electrical generator in another aspect.

### DETAILED DESCRIPTION OF THE ILLUSTRATED EMBODIMENTS

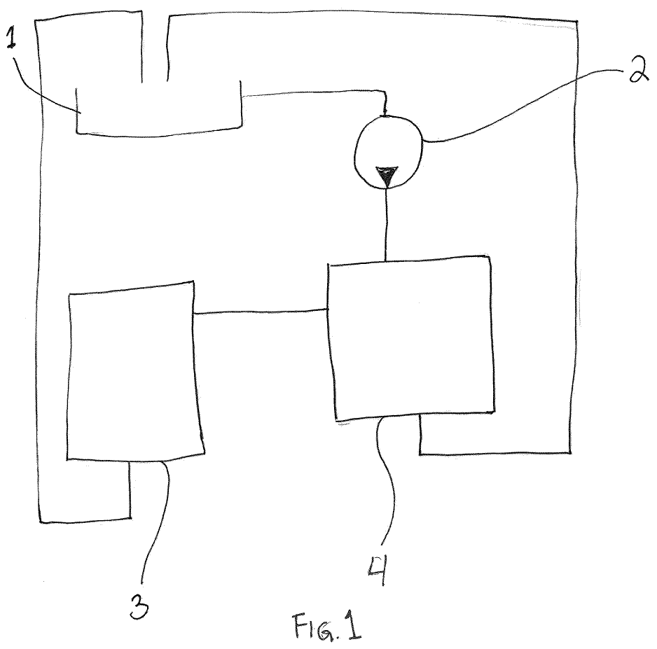

FIG. 1 Illustrates a Hydraulic System for Use on a Piece of Mobile Equipment, Such as an excavator. The hydraulic system can have a single hydraulic fluid source 1 and a hydraulic pump 2, fluidly connected to the hydraulic fluid source 1, which supplies hydraulic fluid to both: a main hydraulic circuit 3, to drive hydraulic components in the main hydraulic circuit 4, and a hydraulic generator circuit 4, which includes a hydraulic generator. Hydraulic fluid is supplied to the hydraulic generator circuit 4 by the hydraulic pump 2 before hydraulic fluid is routed to the main hydraulic circuit 3 to prioritize the flow of hydraulic fluid to the hydraulic generator circuit over the main hydraulic circuit 3.

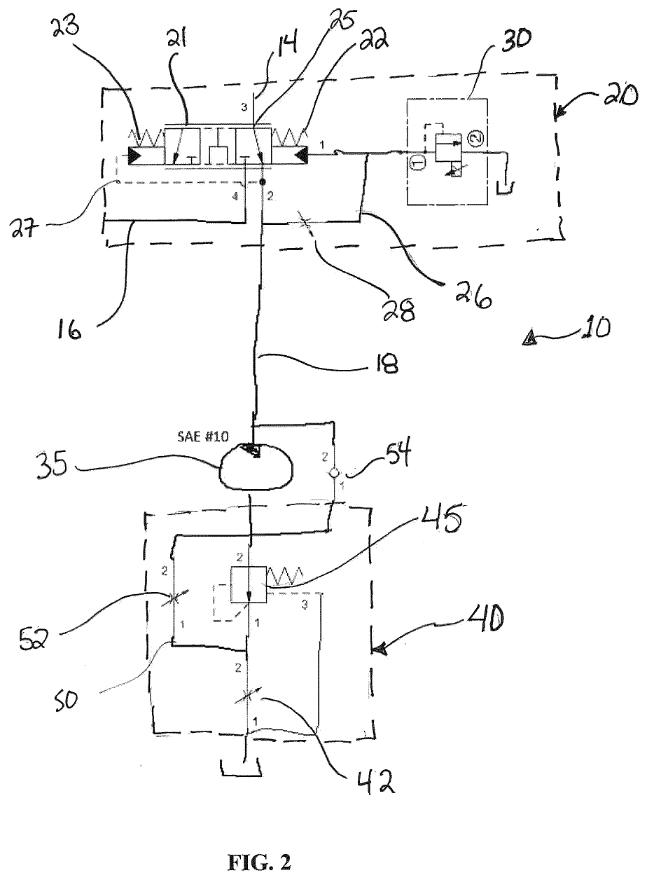

FIG. 2 illustrates a hydraulic generator circuit 10 to drive an electrical generator 35, such as the hydraulic generator circuit 4 shown in FIG. 1. The hydraulic generator circuit 10 can have: a hydraulic fluid input 14; a meter in pressure control assembly 20; an electrical generator 35; and, a meter out flow control assembly 40. The hydraulic circuit 10 can be provided on mobile equipment to provide a hydraulically driven electrical generator 35 on the mobile equipment in addition to the main hydraulic circuit that hydraulicly powers various other hydraulic components on the mobile equipment.

Hydraulic fluid from a source of pressurized hydraulic fluid, such as the hydraulic pump 2 being fed by the reservoir 1 as shown in FIG. 1, enters the hydraulic circuit 10 through the hydraulic fluid input 14. This hydraulic fluid can be divided between being routed through a main supply line 16 which routes hydraulic fluid to the main hydraulic circuit (not shown) to hydraulically power other components and a generator supply line 18 to route hydraulic fluid to the electrical generator 35 to drive the electrical generator 35.

This hydraulic fluid will flow through the meter in pressure control assembly 20 where the meter in pressure control assembly 20 will direct the hydraulic fluid between the main supply line 16 and the generator supply line 18 and maintain the hydraulic fluid that is flowing through the generator supply line 18 to the electrical generator 35 at a substantially constant desired operating pressure. The use of meter in pressure control is more stable than meter in flow control and can be adapted to various hydraulic pump configurations, allowing the hydraulic circuit 10 to be added to a number of existing hydraulic systems on various different types of mobile equipment.

After passing through the meter in pressure control assembly 20, the hydraulic fluid will flow to and through the electrical generator 35 where the electrical generator 35 will supply electrical power to electrical components (not shown).

After the electrical generator 35, the hydraulic fluid that has passed through the electrical generator 35 flows through the meter out flow control assembly 40 that maintains a constant volume flow rate of the hydraulic fluid through the electrical generator 35.

The meter in pressure control assembly 20 can include: a priority valve 21; an orifice 28, and, a pressure relief valve 30. The priority valve 21 can be hydraulicly activated and have a first hydraulic actuation 22 and a second hydraulic actuation 23. The first hydraulic actuation 22 can be biased, such as with a spring, so that it requires a pressure threshold (i.e. 100 psi) to overcome this bias and be moved.

Hydraulic fluid that enters the meter in pressure control assembly 20 can enter the priority valve 21 through an input 25. The priority valve 21 operates to: supply all of the hydraulic fluid to the generator supply line 18 in a first position; supply the hydraulic fluid to both the main supply line 16 and to the generator supply line 18 in a second position; or, supply all of the hydraulic fluid to a main supply line 16 in a third position. The priority valve 21 can be biased to be in the first position, giving priority to hydraulic fluid being directed to the generator supply line 18 over the main supply line 16.

Some hydraulic fluid is routed from the generator supply line 18 through a diverting line 26 and through the orifice 28, such as an adjustable orifice, to both the pressure relief valve 30 and the first hydraulic actuation 22 of the directional valve 20.

A pilot line 27 can run from the generator supply line 18 to the second hydraulic actuation 23 on the directional valve 20. Although the pilot line 27 is shown external to the priority valve 21 in FIG. 2, it would typically be integral to the priority valve 21.

While the pressure of the hydraulic fluid passing through the priority valve 21 is below the desired operating pressure, the priority valve 21 will be in first position, supplying all of the hydraulic fluid to the generator supply line 18. In one aspect, this desired operating pressure would be approximately 3,000 psi. When the pressure of the hydraulic fluid in the generator supply line 18 increases to the desired operating pressure and above, the pressure of the hydraulic fluid routed through the pilot line 27 to the second hydraulic actuator 23 can overcome the bias of the spring and shift the priority valve 21 to the second position, supplying hydraulic fluid to both the generator supply line 18, at the desired operating pressure, and directing excess hydraulic fluid to the main supply line 16 and thereby to the main hydraulic circuit (not shown).

In this manner, the pressure of the hydraulic fluid passing through the generator supply line 18 to the generator 35 is kept substantially constant at the desired operating pressure, with excess hydraulic fluid being routed to the main supply line 16 and to the main hydraulic circuit (not shown) to power the other hydraulic components on the mobile equipment, thereby prioritizing hydraulic fluid flow to the electrical generator 35 and ensuring the electrical generator 35 is supplied with hydraulic fluid at the desired operating pressure to drive the electrical generator 35.

If the hydraulic pressure in the generator supply line 18 exceeds the desired operating pressure, the pressure relief valve 30 limits the hydraulic pressure on the first hydraulic actuator 22, causing the priority valve 21 to move to its third position and stopping the supply of hydraulic fluid to the generator supply line 18 and supplying all of the hydraulic fluid to the main supply line 16 and therefore the main hydraulic circuit (not shown).

When the priority valve 21 is in the second position, supplying hydraulic fluid to both the main supply line 16 and the generator supply line 18, and the pressure in the generator supply line 18 and therefore the pressure of the hydraulic fluid flowing to the electrical generator 35 decreases below the desired operating pressure, the pressure of the hydraulic fluid supplied to the second hydraulic actuation 23 will decrease and the priority valve 21 will move back towards its first position, supplying more hydraulic fluid to the generator supply line 18 until the pressure once again rises to the desired pressure.

In this way, the priority valve 21, the orifice 28, the pilot line 27 and the pressure relief valve 30 making up the meter in pressure control assembly 20 can supply hydraulic fluid at a constant pressure to the generator 35.

Downstream from the generator 35, the meter out flow control assembly 40 controls the flow of the hydraulic fluid out of the electrical generator 35. The meter out flow control assembly 40 can include a pressure compensated flow control valve with a first variable orifice 42 and a pressure reducer valve 45. By using a pressure compensated flow control valve, a constant volume flow rate of hydraulic fluid passes through the pressure compensated flow control valve, regardless of the pressure drop across the pressure compensated flow control valve, therefore controlling the flow rate of the hydraulic fluid passing through the electrical generator 35.

Hydraulic fluid that has passed through the electrical generator 30 will flow to the pressure reducing valve 45 and then through the variable orifice 42. If the pressure differential of the hydraulic fluid upstream of and downstream from the first orifice 42 increases above a trigger amount, the pressure reducing valve 45, which is normally open, can start to close, reducing downstream pressure until it drops below the trigger amount, once again. This trigger amount can be determined by the spring in the pressure reducing valve 45. In this manner, the pressure reducing valve 45 will modulate to maintain a constant pressure drop across the orifice 42 and therefore maintain a constant flow. If the pressure differential across the orifice 42 increases due to an excess flow of hydraulic fluid, the pressure reducing valve 45 will sense this condition and close further.

Meanwhile, a return line 50 can route hydraulic fluid, in parallel to pressure reducing valve 45, through a second orifice 52. The second orifice 52 reduces the metering of the pressure reducing valve 45 and tends to stabilize the meter our flow control function.

When the electrical generator 35 is turned off, the priority valve 21 can keep the pressure in the generator supply line 18 to a value low enough to not overcome mechanical friction in the electrical generator 35 (i.e. the electrical generator 35 comes to a stop). In the time needed for the electrical generator 35 to come to a stop, the pressure in the generator supply line 18 may drop as the supply hydraulic fluid from the priority valve 21 decreases, yet the electrical generator 35 will continue to turn. Flow through the meter out flow control assembly 40 creates pressure on the outlet of electrical generator 35, which is higher than the pressure of the hydraulic fluid in the generator supply line 18. The check valve 54 allows flow from the outlet of the electrical generator 35 to the inlet of the electrical generator 35 to maintain positive pressure of the hydraulic fluid in the generator supply line 18.

The check valve 54 can be an anti-cavitation check valve.

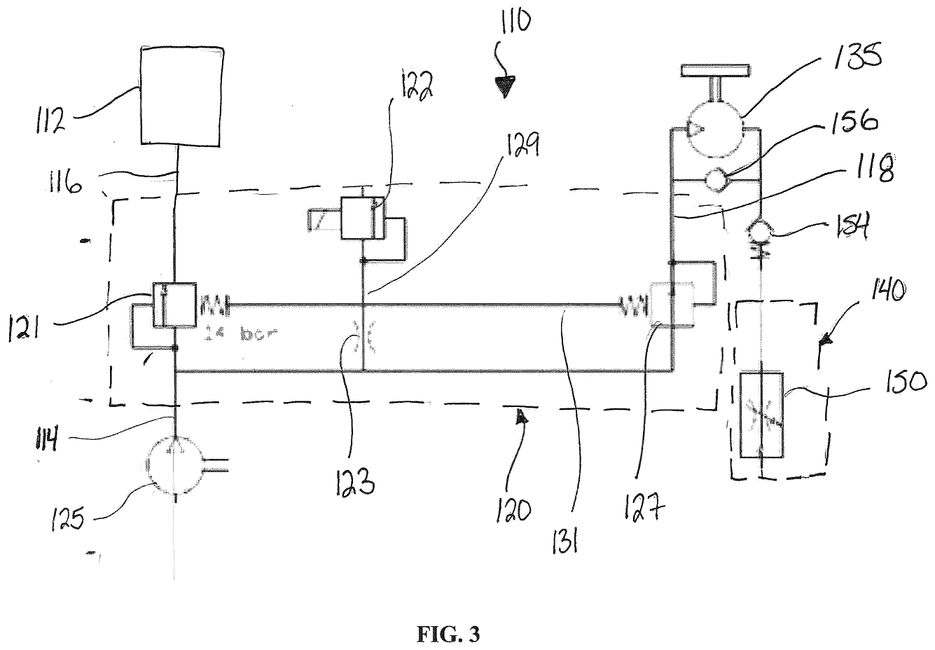

FIG. 3 illustrates a hydraulic circuit 110 to drive an electrical generator 135. The hydraulic circuit 110 can have: a hydraulic fluid input 114; a meter in pressure control assembly 120; an electrical generator 135; and, a meter out flow control assembly 140. The hydraulic circuit 110 can be provided on mobile equipment to provide a hydraulic driven electrical generator 135 on the mobile equipment in addition to the main hydraulic circuit 112 that hydraulicly powers various other systems on the mobile equipment.

Hydraulic fluid from a source, such as a reservoir tank, enters the hydraulic circuit 110 and is pumped through the hydraulic pump 125. The source could be the hydraulic fluid source 1 shown in FIG. 1 and the hydraulic pump 126 can be the hydraulic pump 2 shown in FIG. 1. This hydraulic fluid can be divided between being routed through a main supply line 116 which routes hydraulic fluid to the main hydraulic circuit 112 to hydraulicly power other components and a generator supply line 118 to route hydraulic fluid to the electrical generator 135 to drive the electrical generator 135.

This hydraulic fluid will flow through the meter in pressure control assembly 120 where the meter in pressure control assembly 120 will direct the hydraulic fluid between the main supply line 116 and the generator supply line 118, prioritizing hydraulic fluid through the generator supply line 118 and maintaining the hydraulic fluid that is flowing through the generator supply line 118 to the electrical generator 135 at a desired operating pressure. The use of meter in pressure control is more stable than meter in flow control and can be adapted to various hydraulic pump configurations.

After passing through the meter in pressure control assembly 120, the hydraulic fluid will flow to and through the electrical generator 135 where the electrical generator 135 will supply electrical power to electrical components (not shown).

After the electrical generator 135, the hydraulic fluid that has passed through the electrical generator 135 flows through the meter out flow control assembly 140 that maintains a constant volume flow rate of the hydraulic fluid through the electrical generator 135.

The meter in pressure control assembly 120 can include: a sequence valve 121; a pressure relief valve 122; an orifice 123, and, a pressure reduction valve 127. The sequence valve 121 can be inline of the main supply line 116; between the hydraulic pump 125 and the main hydraulic circuit 112. The pressure reduction valve 127 can be provided inline of the generator supply line 118, upstream form the electrical generator 135.

A portion of the hydraulic fluid from the pump 125 can travel through the generator supply line 118 to the pressure reduction valve 127 before passing through the electric electrical generator 135, while another portion of the hydraulic fluid can travel through the main supply line 116 to the sequence valve 121. Until the pressure of the hydraulic fluid is great enough to cause the sequence valve 121 to open, the sequence valve 121 will be closed, directing the entire flow of hydraulic fluid to the pressure reduction valve 127 and subsequently the electrical generator 135.

The hydraulic fluid that is routed through the generator supply line 118 will pass through the pressure reduction valve 127 causing the pressure of the hydraulic fluid reaching the electrical generator 135 to be reduced to the desired operating pressure if the pressure of the hydraulic fluid reaching the pressure reduction valve 127 is higher than the desired operating pressure. In this manner, the pressure of the hydraulic fluid that reaches the electrical generator 135 will be reduced to the desired operating pressure by the pressure reduction valve 127.

When the pressure of the hydraulic fluid in the generator supply line 118, downstream from the pressure reduction valve 127, and the pressure of the hydraulic fluid in the main supply line 116 reaches the pressure threshold of the sequence valve 121, the sequence valve 121 will start to open and allow some of the hydraulic fluid to pass through the sequence valve 121, to the main hydraulic circuit 112, while maintaining the hydraulic fluid passing through the generator supply line 118 at the pressure threshold. In this manner, the flow of hydraulic fluid through the generator supply line 118 is prioritized, with any additional flow of hydraulic fluid being directed to the main hydraulic circuit 112.

The pressure relief valve 122 pilots sequence valve 121 and pressure reduction valve 127. The orifice 123 can be relatively small, 0.030″ in one aspect, and sized to provide some flow to relief valve 122 and be able to develop pressure in line 129. The sequence valve 121 will open when the pressure threshold is met; the pressure in the main supply line 116 exceeds the pressure in the line 129 plus the spring on the sequence valve 121. The pressure reduction valve 127 is open until the pressure at an inlet to the electrical generator 135 exceeds the pressure in line 129 plus the spring force of the spring on the pressure reduction valve 127, at which point the pressure reduction valve 127 begins to close. As the pressure reduction valve 127 beings to close, the pressure in the main supply line 116 rises and opens the sequence valve 112, allowing hydraulic fluid to flow through the sequence valve 112.

The sequence valve 121 and the pressure reduction valve 127 can be connected by a large diameter fluid conductor 131.

After the meter in pressure control assembly 120, the hydraulic fluid will flow to and through the electrical generator 135 where the electrical generator 135 will supply electrical power to electrical components (not shown).

Downstream from the generator 135, the meter out flow control assembly 140 controls the flow of the hydraulic fluid out of the electrical generator 135. The meter flow control assembly 140 can include a pressure compensated flow control valve 150 that provides a constant volume flow rate passing through the pressure compensated pressure compensated flow control valve 150, regardless of the pressure drop across the pressure compensated flow control valve 150.

Optionally, a first biased check valve 154 can prevent the flow of hydraulic fluid out of the electrical generator 135 until the pressure of the hydraulic fluid passing through the electrical generator 135 reaches a set pressure able to open the check valve. If the minimum pressure for the pressure reduction valve 127 exceeds the pressure to overcome the friction in electrical generator 135 when the electrical generator 135 is turned off, the first biased check valve 154 induces backpressure to the electrical generator 135 and prevents it from turning when the electrical generator 135 is turned off.

When the electrical generator 135 is turned off, in the time needed for the electrical generator 35 to come to a stop, the pressure in the generator supply line 118 may drop as the supply hydraulic fluid decreases, yet the electrical generator 135 will continue to turn. Flow through the meter out flow control assembly 140 creates pressure on the outlet of electrical generator 135, which is higher than the pressure of the hydraulic fluid in the generator supply line 118. The check valve 156 allows flow from the outlet of the electrical generator 135 to the inlet of the electrical generator 135 to maintain positive pressure of the hydraulic fluid in the generator supply line 118.

The check valve 156 can be an anti-cavitation check valve.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A hydraulic circuit for driving an electrical generator, the hydraulic circuit comprising:
an electrical generator connected to one or more electrical components;
a meter in pressure control assembly, upstream from the electrical generator, supplying hydraulic fluid to the electrical generator at a substantially constant desired operating pressure; and
a meter out flow control assembly, downstream from the electrical generator, controlling the flow of hydraulic fluid out of the electrical generator at a substantially constant flow rate.

2. The hydraulic circuit of claim 1 wherein the meter in pressure control assembly comprises a priority valve.

3. The hydraulic circuit of claim 2 wherein the meter in pressure control assembly further comprises a pressure relief valve.

4. The hydraulic circuit of claim 2 wherein the priority valve is positionable between: a first position, supplying all of the hydraulic fluid to a generator supply line; a second position, supplying the hydraulic fluid to both a main supply line and to the generator supply line; and a third position, supplying all of the hydraulic fluid to the main supply line, wherein the main supply line is operatively connected to a main hydraulic circuit.

5. The hydraulic circuit of claim 4 wherein the priority valve is biased to the first position.

6. The hydraulic circuit of claim 4 wherein the priority valve has a first hydraulic actuation and a second hydraulic actuation that controls the position of the directional valve.

7. The hydraulic circuit of claim 4 further comprising a diverting line routed from the electrical generator supply line to the first hydraulic activation and the pressure release valve.

8. The hydraulic circuit of claim 7 wherein the orifice is inline with the diverting line.

9. The hydraulic circuit of claim 1 wherein the meter out pressure control assembly comprises a pressure compensated flow control valve.

10. The hydraulic circuit of claim 1 wherein the meter in pressure control assembly comprises: a main supply line leading to a main hydraulic circuit; a generator supply line leading to the electrical generator; a sequence valve, inline of the main supply line and downstream from the main hydraulic circuit, to prioritize flow to the generator supply line; and, a pressure reduction valve inline of the generator supply line and downstream from the electrical generator.

11. A hydraulic system for a piece of mobile equipment, the system comprising:
a hydraulic fluid source;
a hydraulic pump fluidly connected to the hydraulic fluid source;
a main hydraulic circuit supplied with hydraulic fluid by the hydraulic pump; and
a hydraulic generator circuit, comprising an electrical generator, supplied with hydraulic fluid by the hydraulic pump.

12. The hydraulic system of claim 12 wherein hydraulic fluid is supplied to the hydraulic generator circuit by the hydraulic pump before the hydraulic fluid is routed to the main hydraulic circuit.

13. The hydraulic system of claim 13 wherein the hydraulic generator circuit comprises:
an electrical generator connected to one or more electrical components;
a meter in pressure control assembly upstream from the electrical generator, supplying hydraulic fluid to the electrical generator at a substantially constant desired operating pressure; and
a meter out flow control assembly downstream from the electrical generator, controlling the flow of hydraulic fluid out of the electrical generator at a substantially constant flow rate.

14. The system of claim 12 wherein the meter in pressure control assembly comprises a priority valve.

15. They system of claim 14 wherein the priority valve is positionable between: a first position, supplying all of the hydraulic fluid to a generator supply line; a second position, supplying the hydraulic fluid to both a main supply line and to the generator supply line;
and a third position, supplying all of the hydraulic fluid to the main supply line, wherein the main supply line is operatively connected to the main hydraulic circuit.

16. The system of claim 15 wherein the priority valve is biased to the first position.

17. The system of claim 14 wherein the meter out pressure control assembly comprises a pressure compensated flow control valve.

18. They system of claim 14 wherein the meter in pressure control assembly comprises: a main supply line leading to a main hydraulic circuit; a generator supply line leading to the electrical generator; a sequence valve, inline of the main supply line and downstream from the main hydraulic circuit, to prioritize flow to the generator supply line; and, a pressure reduction valve inline of the generator supply line and downstream from the electrical generator
